(19) United States
(12) Patent Application Publication
(10) Pub. No.: US 2007/0174769 A1
(43) Pub. Date: Jul. 26, 2007

(54) System and method of mapping images of the spine

(75) Inventor: Jeffrey H. Nycz, Collierville, TN (US)

Correspondence Address: HAYNES AND BOONE, LLP, 901 MAIN ST, SUITE 3100, DALLAS, TX, 75202, US

(73) Assignee: SDGI Holdings, Inc., Wilmington, DE (US)

(21) Appl. No.: 11/338,494

(22) Filed: Jan. 24, 2006

(51) Int. Cl. G06F 3/00

(52) U.S. Cl. 715/700

(57) ABSTRACT

The present invention provides systems and methods for enhancing the delivery and display of medical images for preoperative planning and diagnosis. Various characteristics of the data associated with the image or images being viewed may be manipulated and stored. The system and method provide automated annotation of the images to assist accuracy and speed of review.

### FIELD OF THE INVENTION

The present invention generally relates to systems and methods for enhancing the viewing of images of the spine. More particularly, the present invention relates to systems and methods of annotating radiographic images of the spine.

### BACKGROUND OF THE INVENTION

Medical images, such as conventional radiographs (“X-rays”), computed tomography (“CT”) scans, magnetic resonance images (“MRIs”), sonograms, mammograms, nuclear medicine studies and the like, are a vital tool in diagnosis, treatment planning and other aspects of healthcare delivery. One of the more recent advances in medical imaging was the ability to acquire digital images or to scan and digitize images which were originally acquired on radiographic or other non-digital film. Another advance enabled physicians and other healthcare workers to distribute those digital images over a network. One technology which has enhanced the transfer of radiologic images and other medical information between computers is DICOM (Digital Imaging and Communications in Medicine), which is the industry standard for transferring such images and information. Digitization often allows radiologists and other physicians and healthcare workers to more easily manipulate a given image for easier viewing. Distribution over a network allows those healthcare workers to view images from remote locations, such as a another hospital, an office or even a home.

For proper pre-operative planning, a surgeon typically obtains multiple images of the affected anatomical area, such as a spinal column or portion thereof, from multiple views, such as frontal, side and oblique views. This pre-operative planning process helps surgeons determine the optimal correction of the spine and/or the type, size and placement of a device before operating. However, a typical viewer has a size that does not allow the display of all of the spinal segments of the radiographic image to permit a detailed examination of a specific spinal segment. As a result, the surgeon enlarges the view of the segment or segments of interest. However, an enlarged view often eliminates the anatomic landmarks that assist the surgeon in determining which vertebrae are currently being viewed. As a result, errors may be made in the identification of the vertebrae or time is lost in switching between full views showing all the spine segments and the more detailed enlarged view.

Thus, a need exists for systems and methods to enable surgeons and other healthcare providers to more efficiently view and evaluate images to conduct pre-operative planning and other evaluations.

### SUMMARY OF THE INVENTION

In one aspect, the present invention provides a method for labeling radiographic images of the spine. The method comprises displaying a digitized radiographic image of at least a portion of the spine and providing a first prompt to a user with a first annotation representing a first vertebral body. The annotation may be fixed to the radiographic image adjacent a first vertebral body. The method contemplates determining a second annotation associated with a second vertebral body adjacent to the first vertebral body, displaying a second prompt with the second annotation, aligning the second prompt with a second vertebral body and fixing the second annotation adjacent the second vertebral body.

In another aspect, the present invention provides a system for annotation of images of the spine. The system includes a graphic user interface for displaying images and receiving user inputs. The system further includes a processor that accesses a memory for determining a subsequent image label based on the initial image label.

Further aspects, forms, embodiments, objects, features, benefits, and advantages of the present invention shall become apparent from the detailed drawings and descriptions provided herein.

### BRIEF DESCRIPTION OF THE DRAWINGS

FIG. 1 is a representation of a system for obtaining images of the spine.

FIG. 2 is an exemplary screen shot illustrating a graphic user interface in accordance with one aspect of the present invention.

FIG. 3 is an exemplary screen shot illustrating a graphic user interface with a image of the spine in the process of being labeled.

FIG. 4 is an enlarged view of the image of the spine showing the labels applied according to one aspect of the present invention.

FIG. 5 illustrates, in flow diagram form, a method in accordance with one aspect of the present invention.

### DESCRIPTION OF THE PREFERRED EMBODIMENTS

For the purposes of promoting an understanding of the principles of the present invention, reference will now be made to the embodiments illustrated in the drawings, and specific language will be used to describe the same. It will nevertheless be understood that no limitation of the scope of the invention is intended thereby. Any alterations and further modifications in the described devices, instruments, methods, and any further application of the principles of the invention as described herein are contemplated as would normally occur to one skilled in the art to which the invention relates.

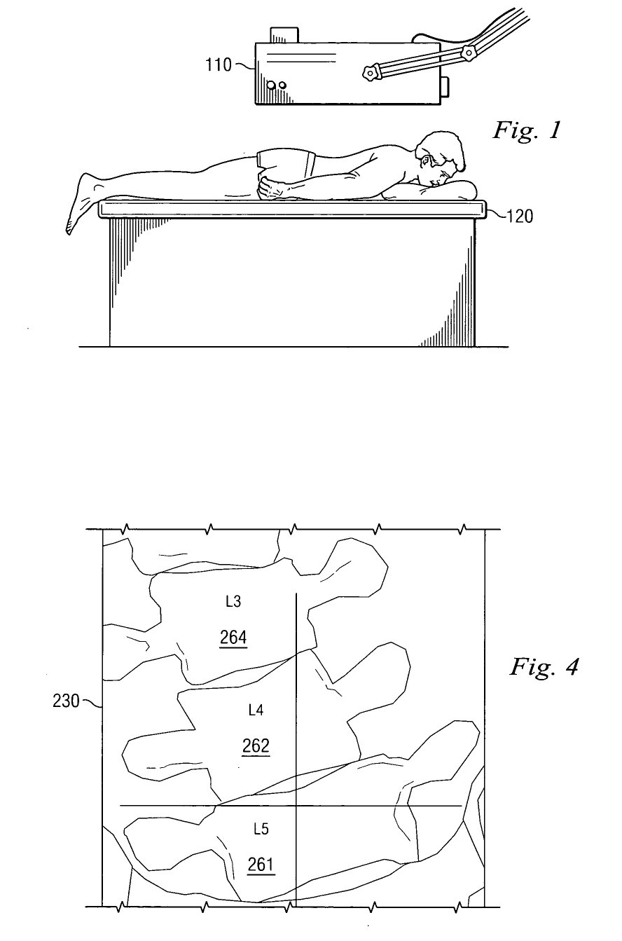

FIG. 1 illustrates a system for obtaining radiographic images of a human spine from an posterior to anterior direction with the patient lying down on table 120. The system includes a radiographic energy source 110 movable with respect to the table 120. The energy is transmitted from source 110 through the patient and received in a target (not shown) which has a sensitivity to the energy used by source 110. The figure is provided the purpose of illustration and no limitation is intended it being understood that any system may be used to gain an image of the skeletal system of the patient and the patient may be positioned in any desired posterior or orientation. For example, but without limitation, the imaging system may be conventional radiographs (“X-rays”), computed tomography (“CT”) scans, magnetic resonance images (“MRIs”), sonograms, mammograms, nuclear medicine studies and the like. For example, but without limitation, the patient may be standing, bending, seated, lying down and the imaging system may take a full or partial image of any portion of the skeletal system from back to front, front to back, side to side, obliquely or may assembly multiple images to build composite images of the spine.

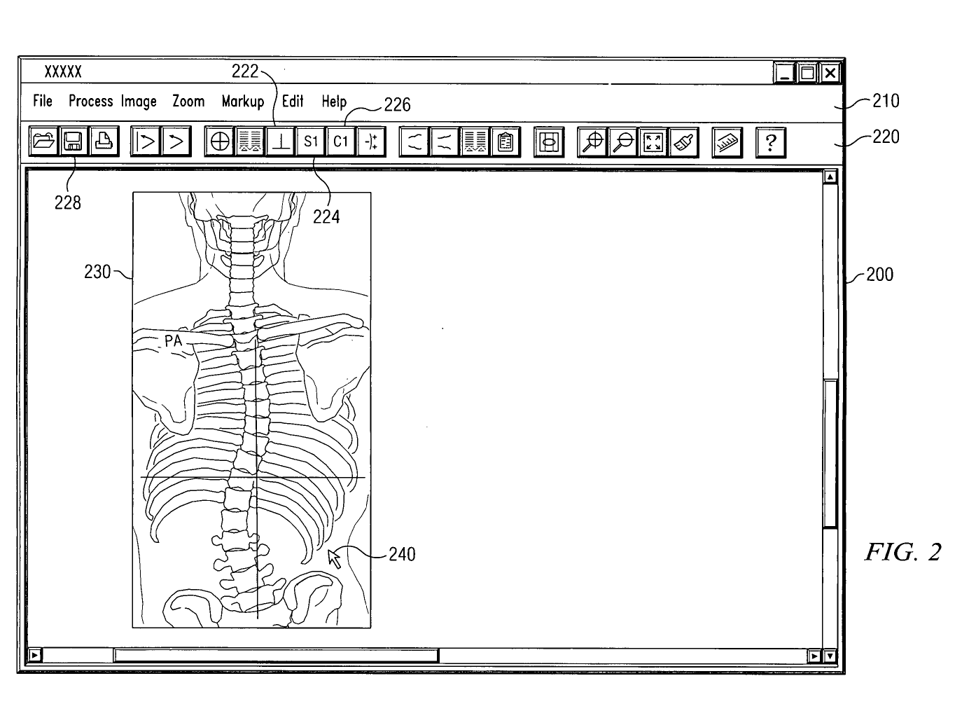

Referring now to FIG. 2, there is shown a stylized posterior to anterior image 230 of a patient's spine. The image may have been created by any appropriate system and provided or converted to an electronic image that may be displayed on a visual display. In one aspect, radiographic image 230 is displayed within a graphic user interface 200 having a menu bar 210 and a tool bar 220 each having a number of functions available for user selection. The radiographic image 230 provides a virtually complete image of the spine from the sacrum adjacent the pelvis up to and including the cervical spine adjacent the cranium. The head or cranium is partially shown at the top of the image and the sacrum is shown at the bottom. It will be understood that the radiographic image 230 is shown with crisp black lines on a white background for the purpose of illustration, however, in practice most radiographic images are hazy white masses on a black background that require a trained professional to properly interpret and understand the significance of the various parts of the image.

In one aspect, the present invention provides a graphic user interface 200 with tools to assist a professional with labeling aspects of the image once they have interpreted what anatomical features are represented by the displayed image. For example, graphic user interface 200 includes an annotation button 222 that when selected will shift the cursor 240 to an annotation mode. In addition, the user may selected an initial annotation by selecting the S1 button 224 or the C1 button 226. In this mode, the user may operate the system to position annotations along the displayed image in association with anatomical features and then fix the appropriate annotation at the desired location on the displayed image for later reference. After completion of the viewing and annotation session, the user may select save button 228 to save the file with the image and associated annotations.

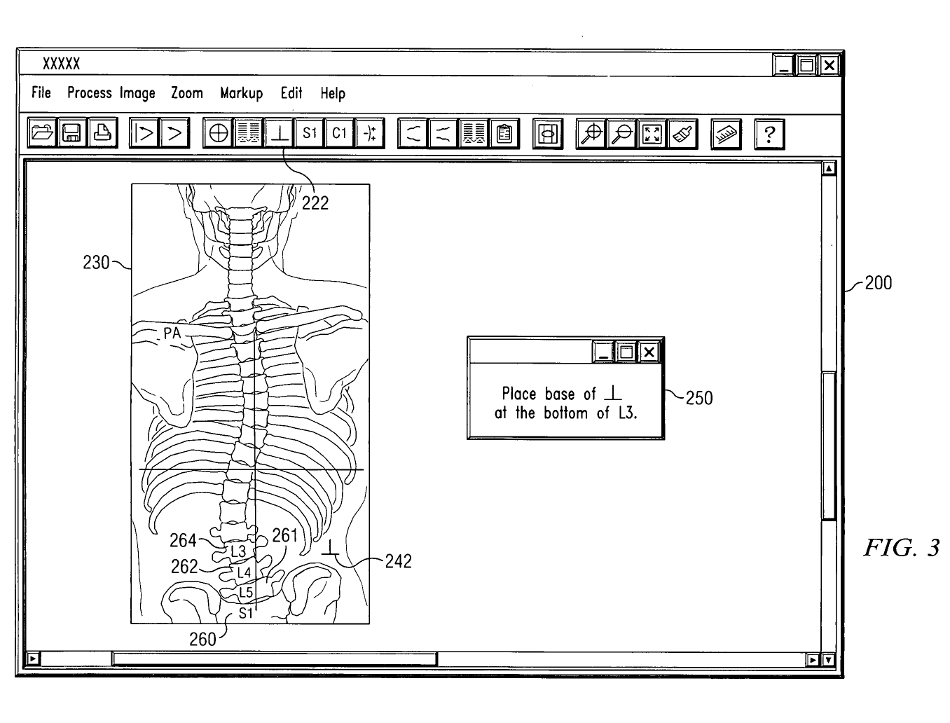

Referring now to FIG. 3, there is shown the image 230 of FIG. 2 in the process of being labeled. Prior to this display, the user selected button 222 from the tool bar to place the graphic user interface in the illustrated labeling mode. Pop up box 250 provides the user with instructions for placement of the next label on the spine and indicates which label will be fixed. In the illustrated embodiment, the label “L3” will be fixed to the image at the cursor 242 location with the next left click of the mouse or other input from a user interface. As explained more fully below, the user may change label that will be fixed by manually changing the system display. Prior to the display of FIG. 3, the cursor 242 had been positioned at the S1 vertebra to fix label 260, at the L5 vertebra to fix label 261 and at the L4 vertebra to fix label 262 adjacent the appropriate positions, respectfully, on the displayed spinal segments. In the illustrated aspect, the user will substantially align the bottom of the cross-hair cursor 242 with the bottom margin of the L3 vertebra. The user will then indicate by mouse click or other user input that the system should fix the displayed label at the location of the cursor. In the illustrated version, the label 264 would be placed immediately above the horizontal line of cross-hair cursor 242. The process of labeling continues as desired by the user until the appropriate amount of labels have been applied such that the user can readily identify the vertebrae of interest in future evaluations.

Referring now to FIG. 4, there is shown an enlarged view of a portion of the radiographic image 230 shown in FIG. 3. In the enlarged view only a few vertebrae are visible and the anatomic landmarks associated with the entire spine are not visible. In this enlarged view, a professional viewing the image can make more effective evaluations of the image. In the illustrated image, labels 261, 262 and 264 have been applied to the image such that the viewer can readily identify the vertebral bodies with certainty in making recommendations for treatment or evaluating the condition of the spine. It will be understood that the user can scroll up or down the image and the associated labels will be displayed as new vertebrae come into the viewable area of the display.

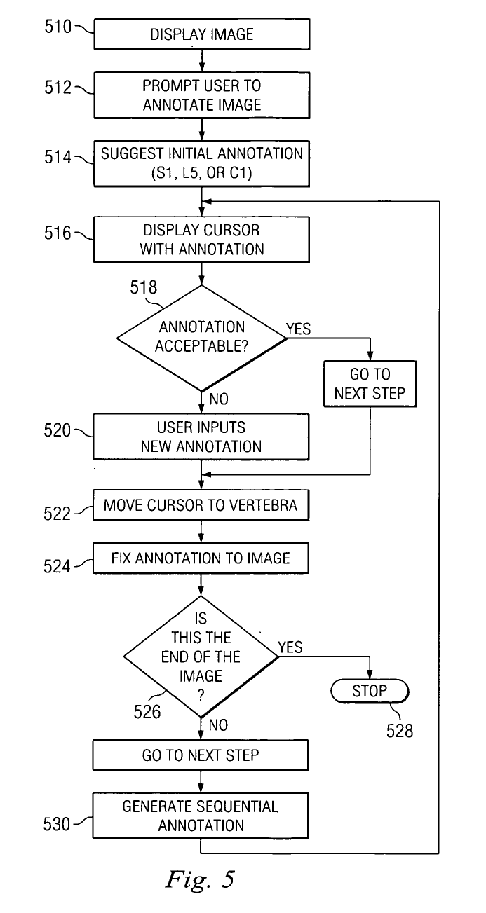

Referring now to FIG. 5, there is shown a process according to one aspect of the present invention. An image, similar to that shown in FIG. 2, is displayed to the user in step 510. The system then prompts the user to annotate the image in step 512. At step 514, the system determines a likely initial marker for the first vertebra. In one aspect, the system will suggest the upper portion of the spinal column and provide C1 as the initial annotation. Alternatively, the initial annotation may be associated with the lower most portion of the spine and provide S1 as the initial annotation. Still further, the system provides the ability for the user to define the initial annotation to be displayed each time the system is activated. At step 516, the system displays a cursor and the initial annotation.

At step 518, the user may modify the initial annotation. It may be that the radiographic image does not display the superior or inferior regions. Additionally, the user may only want to label a portion of the spine. If the user wants the spine level indicator to change, the user may manually adjust the displayed annotation at step 520. Once the user is satisfied with the displayed spine level label, the process continues to step 522 where the user positions the cursor adjacent to the spine level corresponding to the annotation. The user may then click the mouse, or use another interface tool such as a keyboard, to drop the label on the image and fix it in position. Once the user has dropped the label onto the image, the system will determine the next sequential label for the spine in step 530. For example, if the initial label was C1, the system would update the label to the adjacent inferior vertebra C2 and display the updated label by returning to step 516. Thus, in one embodiment the system steps from the superior vertebra to the adjacent inferior vertebra. In an alternative embodiment, the system indexes from the inferior vertebra to the adjacent superior vertebra. The process continues from steps 516 to 530 until the system determines it has reached the end of the spine. If it is indexing from superior to inferior spinal segments, then this will occur after displaying S1. If the system is indexing from inferior to superior spinal segments, then this will occur after displaying C1. Alternatively, the system permits the user to manually exit the labeling cycle.

In one aspect of the present system, the user need only position the cursor within the border of the vertebral body and fix an annotation to the image. Alternatively, if the label will inhibit proper viewing of the image, then the label may be fixed adjacent to, but outside the boundaries of the vertebra. In this manner, the user may visually identify the vertebra, even when the image is enlarged to show less than the entire spinal column.

In another aspect of the present invention, the system may prompt the user to position the cursor on the superior endplate of the vertebrae. The system may then calculate the relative position of each of the vertebrae based on the spacing of the labels. During viewing after the labeling process, the cursor will display the nearest vertebrae's label to the user.

In yet a further embodiment, the process can add an additional function of approximating the boundaries of the vertebral bodies in association with placing the labels. Specifically, the cursor displayed in step 516 may include directional crosshairs. In the disclosed embodiment, the user is prompted to initially place the cursor on the lower right corner of the displayed vertebra. The system prompts the user to substantially align the vertical portion of the crosshair with the vertical side wall of the vertebral body and the horizontal portion of the crosshair with the horizontal endplates of the vertebra. The system includes a graphic user interface that allows the user to rotate the crosshairs into substantial alignment with the sidewall and endplate of the vertebra. Once the crosshairs are in alignment, the user may select this location to indicate the lower right corner of the vertebra. Once the lower right corner is selected, the user is prompted to determine the upper left comer. As described above, the user may manipulate the cursor until it is in substantial alignment with the upper left corner of the vertebra. The user then fixes the crosshair to the image to select the upper left corner of the vertebra. With these data points, the system may then calculate the approximate area occupied by the image to the vertebra with the label. For more exact mapping the vertebral boundaries, the system may prompt the user to enter more data points indicating the boundaries of the displayed image. Thus, as the cursor passes over the defined area, the system will recognize the vertebra and display the associated label. In addition to the visual display, the system may record the vertebra label for measurements made using the system.

In another aspect of the invention, it is contemplated that the recorded information concerning labeling and/or boundaries of the vertebrae may be used in other diagnostic procedures. For example, but without limitation, the user may define a Cobb angle between two vertebrae by selecting the starting point and the ending point. The system may then calculate the angle. In the present invention, the system would retrieve the stored information concerning each of the selected points and insert the corresponding label for the starting and ending points. The label information would then be displayed with the calculated Cobb angle. In a similar manner, the user may define two points to determine a disc height between two adjacent vertebrae. The system would retrieve the store label data for the associated vertebrae and automatically display the label information with the disc height measurement. In a similar manner, it is contemplated that with the current invention any measurements or other landmark identification the stored label information could automatically be displayed or otherwise associated with the desired output to eliminate the requirement that the user manually enter the information.

It is contemplated that the current system of labeling of spinal segments may also be useful with images interpreted and mapped by machine readers. Specifically, certain computer programs may determine the approximate boundaries or edge of the vertebral body images displayed in a radiograph image by recognition of the change in density of the black or white image. Once the boundaries have been identified, a process according to the present system may be used to automatically label the vertebrae. Specifically, a user may select the initial annotation and associate it with a vertebrae. Once this is done, the system will automatically label the remaining vertebrae extending superiorly and inferiorly from the initial reference vertebrae as they were previously mapped by the machine reader.

While the foregoing description was provided with respect to labeling the individual vertebral bodies the described system may be used for other labeling procedures in the spine. For example, but without limitation, the labels may include additional information about the anatomic features or may be placed to label the features of the disc space. Further, additional labels may be placed at each spine segment to identify other features such as, pedicles, facets, spinous process, etc.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. A method for labeling images of vertebrae of the spine, comprising:
displaying a digitized image of at least a portion of the spine;
providing a first prompt to a user with a first annotation representing a first vertebral body;
positioning the prompt adjacent a first vertebral body;
fixing the first annotation adjacent the first vertebral body;
determining a second annotation associated with a second vertebral body adjacent to the first vertebral body;
displaying a second prompt with the second annotation;
positioning the second prompt adjacent a second vertebral body; and
fixing the second annotation adjacent the second vertebral body.

2. The method of claim 1, wherein the providing step includes providing an S1 label.

3. The method of claim 1, wherein the providing step includes providing an L5 label.

4. The method of claim 1, wherein the providing step includes providing a C1 label.

5. The method of claim 1, wherein the determining step includes indexing to the next adjacent superior vertebra.

6. The method of claim 1, wherein the determining step includes indexing to the next adjacent inferior vertebra.

7. The method of claim 1, further including aligning the first prompt in a first location approximating a first corner of a image of a vertebra and fixing the first location, aligning the prompt with a second location approximating a second corner, diagonally opposite the first corner, of the image of the vertebra and fixing the second location; and mapping the area between the first location and second location, wherein said fixing the first annotation occurs within the mapped area.

8. The method of claim 7, wherein the method further includes displaying the annotated image and the annotation is displayed within the mapped area.

9. The method of claim 7, wherein the aligning the first prompt is repeated for each successive vertebrae of the image, each displayed vertebrae being mapped.

10. The method of claim 7, wherein said aligning includes rotating the prompt to correspond to the angular orientation of the endplate of the vertebra.

11. The method of claim 10, further including aligning the prompt with a sidewall of the vertebra.

12. A system for annotation of an image of vertebrae of the spine, comprising:
a graphic user interface for displaying a image and receiving user inputs;
a means for receiving user inputs of a first image label;
a processor for determining a subsequent image label based on the first radiographic image label; and
a memory unit to store the image with at least the first radiographic image label and the subsequent image label.

13. The system of claim 12, wherein the processor generates an image label for the adjacent superior vertebra.

14. The system of claim 12, wherein the processor generates an image label for the adjacent inferior vertebra.

15. A method for labeling images of vertebrae of the spine, comprising:
displaying an image of at least a portion of the spine including vertebrae;
prompting a user to label at least one of the displayed vertebrae;
receiving an initial vertebra label; and
determining a subsequent vertebra label based on the initial vertebra label.

16. The method of claim 15, wherein said prompting includes suggesting the initial vertebra label to the user.

17. The method of claim 15, further including determining a second subsequent vertebra label based on the subsequent vertebra label.

18. The method of claim 15, further including fixing the initial vertebra label in relation to at least one of the displayed vertebrae and fixing the subsequent vertebra label to an alternate one of the displayed vertebrae.
